(19) United States
(12) Patent Application Publication
(10) Pub. No.: US 2015/0368924 A1
(43) Pub. Date: Dec. 24, 2015

(54) SOLAR LIGHT POLE ASSEMBLY KIT

(71) Applicant: Lazar Izradel, Tel Aviv (IL)

(72) Inventor: Lazar Izradel, Tel Aviv (IL)

(21) Appl. No.: 14/311,307

(22) Filed: Jun. 22, 2014

(51) Int. Cl. E04H 12/22; F21S 9/03; F21S 8/08; E02D 5/80; E02D 27/42

(52) U.S. Cl. CPC E04H 12/2223; E02D 5/801; E02D 27/42; F21S 8/085; F21S 9/037; F21W 2131/10

(57) ABSTRACT

A kit for a solar light pole assembly includes a threaded anchor element including a shank with a threaded portion formed with auger bit threads for screwing into a ground surface, an upper portion of the shank being formed with a turning-tool-receiving member. A pole receiving member is attached to a flange of the threaded anchor element. A pole element assembly, including at least one pole element, is attached to the pole receiving member, and a light fixture is attached to the pole element assembly.

### FIELD OF THE INVENTION

The present invention relates generally to lamp kits, and particularly to a kit and method for assembling a solar light pole assembly, such as for but not limited to, a garden lamp or street lamp mounted in grass or dirt.

### BACKGROUND OF THE INVENTION

Outdoor solar light poles are known, such as for streets or gardens. They generally consist of one or more solar modules, electrical storage means for storing electrical energy connected to the solar module and one or more bulbs that are illuminated by solar power. The assembly is mounted on a pole and the pole is normally anchored in the ground by cement.

A problem with such prior art solar light poles is the relatively high cost of installation. Most home owners must hire a handyman to do the cement work properly to anchor the pole in the ground, patio and the like. The cost of such labor is often much more than the solar light pole, thus causing many home owners to decide against purchasing the solar light pole.

### SUMMARY OF THE INVENTION

The present invention seeks to provide a DIY (Do It Yourself) kit and method for assembling a solar light pole assembly, as is described more in detail hereinbelow. With the present invention, there is no need for any concrete or masonry work and the home owner can easily mount the solar light pole assembly in grass, dirt or solid floors in about 20 minutes.

The different parts of the kit may be made of plastic (such as without limitation, polycarbonate, or any other suitable engineering plastic), metal (such as without limitation, aluminum, stainless steel, or any other suitable metal), and others.

There is thus provided in accordance with an embodiment of the present invention a kit for a solar light pole assembly including a threaded anchor element including a shank with a threaded portion formed with auger bit threads for screwing into a ground surface, an upper portion of the shank being formed with a turning-tool-receiving member, the shank further including a flange located towards the upper portion of the shank, a pole receiving member attached to the flange of the threaded anchor element, a pole element assembly, including at least one pole element, attached to the pole receiving member, and a light fixture attached to the pole element assembly.

### BRIEF DESCRIPTION OF THE DRAWINGS

The present invention will be understood and appreciated more fully from the following detailed description taken in conjunction with the drawings in which:

FIG. 1 is a simplified perspective illustration of a threaded anchor element of the kit, in accordance with a non-limiting embodiment of the present invention;

FIG. 2 is a simplified perspective illustration of a connector element and omnidirectional spirit level mounted on the threaded anchor element, in accordance with a non-limiting embodiment of the present invention;

FIG. 3 is a simplified perspective illustration of an anchor base mounted on the threaded anchor element, in accordance with a non-limiting embodiment of the present invention;

FIG. 4 is a simplified perspective illustration of a turning tool used to screw the threaded anchor element into the ground or other mounting surface, in accordance with a non-limiting embodiment of the present invention;

FIG. 5 is a simplified perspective illustration of pole elements connected to each other and mounted to the anchor base and threaded anchor element, in accordance with a non-limiting embodiment of the present invention; and

FIG. 6 is a simplified perspective illustration of the finished solar light pole assembly, in accordance with a non-limiting embodiment of the present invention.

### DETAILED DESCRIPTION OF EMBODIMENTS

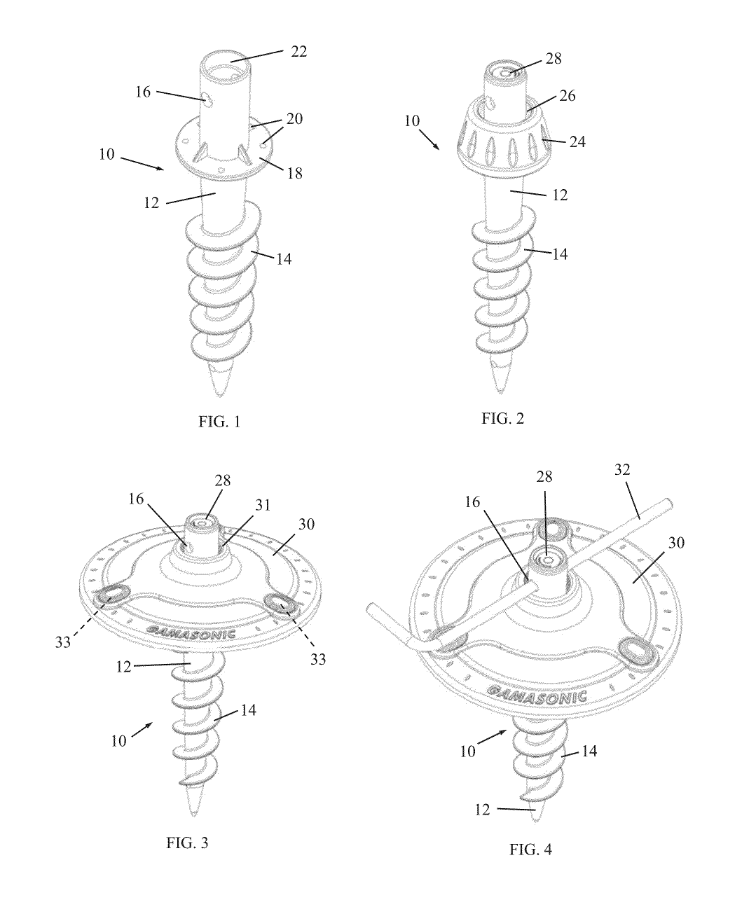

Reference is now made to FIG. 1, which illustrates a threaded anchor element 10 of the kit for a solar light pole assembly, in accordance with a non-limiting embodiment of the present invention. The threaded anchor element 10 includes a shank 12 with a threaded portion 14 formed with auger bit threads for screwing into the ground. The upper portion of shank 12 is formed with a turning-tool-receiving member 16 (such as an aperture 16; alternatively, the shaft could be formed with an Allen-wrench socket or wrench flats, for example) for accepting a turning tool (shown later in FIG. 4). Shank 12 may also have a flange 18 with mounting provisions 20 (such as through holes), located towards the upper portion of shank 12. The top of shank 12 may include a recess 22 for mounting therein other elements, such as described below.

Reference is now made to FIG. 2. A connector element 24 is mounted over flange 18 (seen in FIG. 1). The connector element 24 is preferably formed with internal threads 26 for connecting other elements of the kit thereto. An omnidirectional spirit level 28 is mounted in recess 22 of threaded anchor element 10.

Reference is now made to FIG. 3. An anchor base 30 is mounted on threaded anchor element 10. For example, without limitation, anchor base 30 may be attached with screws (not shown), placed through the mounting provisions 20 of flange 18. The anchor base 30 may include an internally threaded central boss 31 for connection later to pipe elements (in which case there is no need for the connector element 24 attached to threaded anchor element 10); alternatively, anchor base 30 may fit over connector element 24.

Reference is now made to FIG. 4. In order to install the threaded anchor element 10 into the ground, a turning tool 32 is inserted through aperture 16 and can be turned and torqued to screw threaded anchor element 10 into the ground or other mounting surface. The omnidirectional spirit level 28 is helpful in maintaining the threaded anchor element 10 vertical with respect to the ground during turning of the threaded anchor element 10.

It is important to note that the kit may also be assembled on a solid surface, such as but not limited to, a concrete, tile or wooden surface. In such a case, the threaded anchor element 10 is not used, and instead the anchor base 30 is attached directly to the solid surface. For example, anchor base 30 may be provided with mounting fasteners 33 (the option being pointed by the broken arrow 33 in FIG. 3), such as but not limited to, three equally spaced screws or molly bolts. In such an embodiment, the omnidirectional spirit level 28 is mounted on the top of anchor base 30 for proper leveling of the base in the mounting surface.

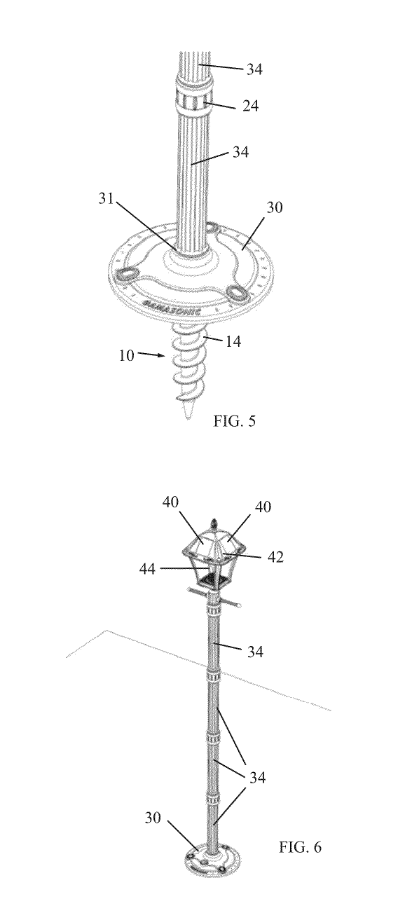

Reference is now made to FIG. 5. After anchoring threaded anchor element 10 into the ground or other mounting surface, a pole element 34 may be connected to the threaded central boss 31 of anchor base 30 (or to the internally threaded connector element 24 shown in FIG. 2) and threaded anchor element 10. For example, the pole element 34 may have an external (male) thread for such threaded connection. (The anchor base 30 and connector element 24 are thus examples of pole receiving members.) As seen in FIG. 5, a plurality of pole elements 34 may be connected to each other, such as by their ends screwing into adjacent connector elements 24.

Instead of screwed connections, other connectors may be used, such as but not limited to, pins, snap-fit connections, press-fit connections, adhesive, etc.

Reference is now made to FIG. 6. The finished solar light pole assembly includes solar photovoltaic panels 40, electrical storage means 42 (e.g., batteries) for storing electrical energy connected to the panels 40, and one or more bulbs 44 that are illuminated by solar power. The assembly is mounted on the pole elements 34.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

1. A kit for a solar light pole assembly comprising:
a threaded anchor element comprising a shank with a threaded portion formed with auger bit threads for screwing into a ground surface, an upper portion of said shank being formed with a turning-tool-receiving member, said shank further comprising a flange located towards the upper portion of said shank;
a pole receiving member attached to said flange of said threaded anchor element;
a pole element assembly, comprising at least one pole element, attached to said pole receiving member; and
a light fixture attached to said pole element assembly.

2. The kit according to claim 1, wherein said pole element assembly comprises a plurality of pole elements connected to each other with connector elements.

3. The kit according to claim 1, further comprising an omnidirectional spirit level mounted on said threaded anchor element.

4. The kit according to claim 1, wherein said pole receiving member comprises an anchor base.

5. The kit according to claim 4, further comprising an omnidirectional spirit level mounted on said anchor base.

6. The kit according to claim 1, wherein said pole receiving member comprises a connector element.

7. The kit according to claim 1, further comprising a turning tool for turning said threaded anchor element.

8. The kit according to claim 1, wherein said light fixture comprises solar photovoltaic panels, electrical storage means for storing electrical energy connected to said panels, and one or more bulbs that are illuminated by solar power.

9. A method for assembling a solar light pole assembly comprising providing the kit of claim 1 for screwing the threaded anchor element portion into the ground surface with the auger bit threads.

10. The method according to claim 9, wherein a portion of said shank is formed with a turning-tool-receiving member, and the method includes inserting a turning tool in said turning-tool-receiving member and turning said turning tool to screw the threaded anchor element into the ground.
